(19) United States
(12) Patent Application Publication
(10) Pub. No.: US 2006/0277567 A1
(43) Pub. Date: Dec. 7, 2006

(54) System and method for targeting audio advertisements

(76) Inventor: D. Scott Kinnear, Sammamish, WA (US)

Correspondence Address: DEAN A. CRAINE, STE 140, 400 - 112TH AVENUE NE, BELLEVUE, WA, 98004, US

(21) Appl. No.: 11/147,001

(22) Filed: Jun. 7, 2005

(51) Int. Cl. H04N 7/10; G06F 13/00; H04N 7/025; G06F 3/00; H04N 5/445

(52) U.S. Cl. 725/34; 725/35; 725/46

(57) ABSTRACT

An improved system and method and system for advertising to audio program listeners that uses an embedded main signal from an audio program service that contains an audio program file, advertisement audio file, program information file, and advertisement audio information file to a listener's addressable digital audio recording device (DAR). When the signal is received by DAR two audio and advertisement program files and the two data information files are separated and stored locally in separate databases. The audio program file may be delivered directly to the listener's DAR for immediate listening. The audio program data information file contains the target demographic profile information and the commercial break information for the audio program. The advertisement audio file and the advertisement data information file are stored in an advertisement library file database and advertisement information file, respectively. Loaded into the memory of the DAR is an advertisement play list generator software program that generates a list of advertisements stored on the DAR recorder to be played back during the audio program.

### BACKGROUND OF THE INVENTION

1. Field of the Invention

This invention relates to systems and methods for advertising to audio listeners, and more particularly, to improved systems and methods of more efficiently targeting advertisements to audio listeners.

2. Description of the Related Art

Audio programs are transmitted to listeners over an airway broadcast network, a telephone line or cable network, or a satellite network. The audio programs, which may be live or pre-recorded, are transmitted twenty-four hours a day, seven days a week. For commercial networks, a main source of revenue is derived from advertising between and during their audio programs.

Advertisers target advertisements to listeners of a particular audio program. Typically, the audio networks will poll potential listeners in different demographic groups to determine the “general” demographics of listeners. Advertisers are then offered advertising “slots” before and during the program to present advertisements to these listeners. Unfortunately, many audio programs have a very diverse and large audience. Advertisers on these programs are presented to listeners who fall outside of the targeted demographics for the advertisers products. For these “non-targeted” listeners, the advertisements presented are less or totally non-effective. (i.e. targeting beer to a non-drinker).

It is postulated that one reason why listeners ‘channel surf’ between radio stations during advertisements, is due to their disinterest in the products or services presented in the advertisements. If specific advertisements could be targeted to interested listeners, ‘channel surfing’ would be reduced therefore making it more likely that the advertisements would be heard. Unfortunately, under the currently available audio advertisement models, targeting specific advertisements to individuals is not possible.

Another problem with the currently audio advertisement model is that it does not meet the advertising needs of local, neighborhood businesses. Because the majority of customers of many local neighborhood businesses are located within a 5 to 10 mile radius of the business, the delivery of advertisements to listeners outside a 5 to 10 mile radius of a business is inefficient.

Audio tape recorders, optical disc recorders, flash memory devices and any program previously recorded to be played back later on the internet are commonly used by listeners to record selected audio programs for later listening, hereinafter called ‘time shifted’ listening. The main benefit of recording a program is that it allows the listener to listen to audio programs at a more convenient time. Another benefit is that it allows a listener to delete or skip advertisements presented during the program. Obviously, deleting or skipping over advertisements is more likely if the advertisement is not targeted to the listener. The increase in ‘time shifted’ listening is a major concern to audio program providers and advertisers who are now searching alternative systems and methods of advertising.

Audio programs transmitted via satellite subscription services are now available. If satellite subscription services could target their advertisements to specific individuals, and receive verification that the advertisements were reviewed by the subscriber a new revenue model could be created in which the cost of the service could be adjusted by the number of advertisements reviewed. For example, a base fee of $10 per month would be charged to each subscriber that could be reduced by a small charge (0.05) for each advertisement heard. Those listeners who do not opt for a subscription service would receive a full range of advertisement tolerance from zero to 500 per month. Advertisements would then be played when the receiver was first turned on and at specific times during the hour or at the prompting of the user.

### SUMMARY OF THE INVENTION

Disclosed herein is a system and method for improved targeting of audio advertisements to listeners of broadcast, cable or satellite audio programs in which a plurality of audio advertisements are downloaded from the network or cable operator, or from satellite operator onto a listener's audio recording device. The audio advertisements that are downloaded into the audio recording device are then selected by a proprietary software program, also loaded into the audio recording device, that selectively controls playback of the audio advertisements during commercial breaks in the audio program.

The system and method uses an embedded signal from the network, cable or satellite transmitter to an addressable audio recording device (called a FRD), such as a tape recorder, a MP3 recorder, PDA or optical disc recorder. The main signal comprises four secondary files: an audio program file, an audio advertisement file, an audio program data file, and an audio advertisement data file. When the main signal is received by the audio recording device, the four secondary files are separately stored in an audio program library database, an audio advertisement library database, an audio program information database, and an audio advertisement information database, respectively.

When connected to the service, the audio program data file may be delivered directly to the listener's audio recording device for immediate listening or storage in the audio program library databank for later listening. Each audio program file is associated with an audio program data file that contains demographic information for target listeners. The audio program file also contains information regarding the number of advertisement breaks or slots in the audio program file, their relative time location in the audio program file, and their duration.

The audio advertisement files are downloaded from the service provider into the audio advertisement library databank while listening to an audio program file or at off times during the day. As stated above, associated with each audio advertisement file is an audio advertisement data file that contains formation regarding the general subject of the product or service sold in the audio advertisement file, the demographic information target listeners of the audio advertisement file, and the length of the audio advertisement file. The associated audio advertisement data files are stored in the audio advertisement information databank.

Loaded into the working memory of the audio recording device is an advertisement audio generator software program that determines which audio program file is currently being heard and examines the audio program data file associated with the audio program file to determine the number of commercial breaks in the audio program file, their exact location in the audio program file, and their duration in the program. The advertisement audio generator software program then instructs a second program called an advertisement play list generator software program also loaded into the working memory of the audio recorder device to select a set of audio advertisement files from the audio advertisement library database to be played during the commercial breaks in the audio program file. When a particular audio program is selected by a listener, the audio generator software program and the advertisement play list generator software program operate automatically to quickly creates a set audio advertisement files to be shown to the listener taking into consideration the information in the audio program data file, the audio advertisements data file, and the listener's demographic information provided by the service provider.

When the listener hears a “live” program, the audio advertisement files that accompany the audio program file may be heard in place of the audio advertisements files already downloaded and stored in the audio advertisement library information database. When the listener ‘channel surfs’ during a commercial break, the audio recorder device may quickly modify the play list of audio advertisements already assembled with a new play list of audio advertisement files that takes into consideration the new audio program and its schedule of commercial breaks.

In the preferred embodiment, the audio program files, the audio advertisement files, the audio program data files, and the audio advertisement data files are delivered simultaneously to the audio recording device. It should be understood, however, that the audio program, the audio advertisement files, the audio program data files and the advertisement data files may be delivered independently at different times. By independently delivering these four files to the audio recording device, each may be individually updated and changed by the network or cable/satellite service or local broadcast stations.

### DESCRIPTION OF THE DRAWINGS

FIG. 1 is a schematic diagram of the audio advertising targeting and playback method and system.

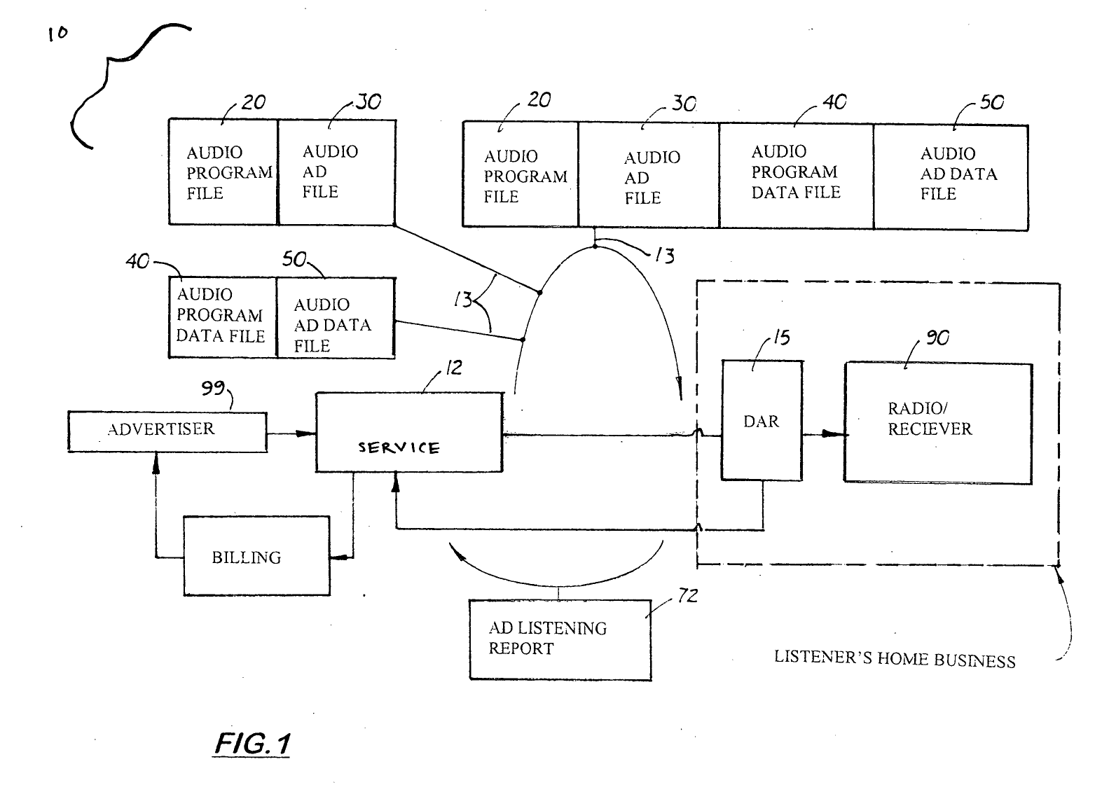

FIG. 2 is a schematic diagram of the embedded signal delivered to a DAR containing a hard drive and working memory.

FIG. 3 is a flow chart of the system.

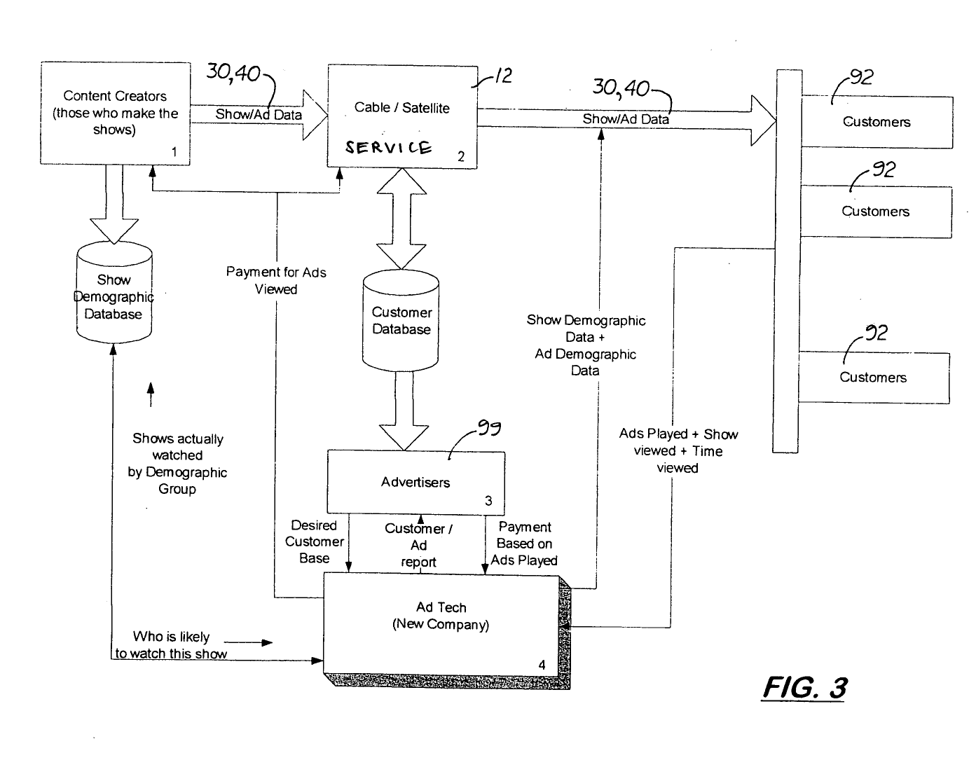

FIG. 4 is a flow chart showing how the audio programs and audio advertisements are processed.

### DESCRIPTION OF THE PREFERRED EMBODIMENT(S)

Referring to Figs, there is disclosed an improved system 10 and method for targeting audio advertising by downloading a plurality of audio advertisement files 30 from a network or cable/satellite service 12 onto a listener's audio recording device 15. The audio advertisement files 30 are stored locally onto an internal long term memory device, such as a hard drive, or tape drive or onto an external device, such as an external hard drive or a network server. The advertisement files 30 are selected and processed by software programs 60, 65 loaded into device's working memory 17 for playing back to the listener immediately or later during the pre-determined advertisement breaks or slots in the audio program file 20.

The system 10 uses an embedded main signal 13 produced by an audio program network or service 12 that is delivered to an addressable audio recording device 15 that includes or connected to an optional display 90. When the main signal 13 is delivered to the audio recording device 15, it is divided via a splitter 16 into four separate files: an audio program file 20, an audio advertisement file 30, an audio program data file 40 and an audio advertisement data file 50.

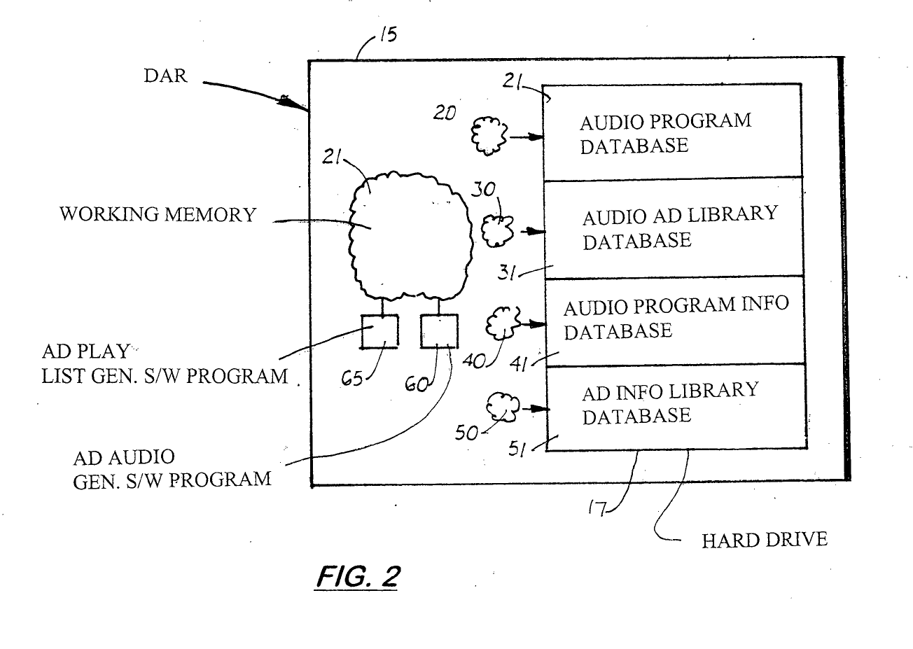

In the preferred embodiment, the audio recording device 15 is a digital audio recorder, hereinafter referred to as a DAR, with one or more hard drives 17 capable of storing several hours of analog and digital audio program files 20, audio advertisement files 30 and data files 40, 50. As shown in FIG. 2, created on the device's hard drive 17 is an audio program library database 21, an audio advertisement library database 31, an audio program information database 41, and an advertisement information library database 51. Loaded into the working memory 18 of the DAR 15 is an advertisement play list generator program 60 and an advertisement audio generator software program 65. The advertisement play list generator software program 60 processes the information from the audio advertisement library database 31, the audio advertisement information database 41 and the audio advertisement information database 51 and delivers it to the vide advertisement generator software program 65. The advertisement generator software program 65 then selects a set of audio advertisement files 30 for delivery to the radio or receiver 90. A show audio generator software program 45 assembles and delivers a selected audio program file 20 from the audio program library database 21 which is combined with a set of audio advertisement files 30 produced by the audio advertisement generator software program 60 to produce a fully integrated audio program 35 for the listener 92.

When the main signal 13 is delivered to the DAR 15, the audio program file 20 may be stored on the device's audio program library database 21 for immediate or later listening. As stated above, associated with each audio program file 20 is an audio program data file 40 that identifies the demographic profile of the targeted listener of the audio program file 20 and the number and lengths of commercial breaks in the audio program file 20. When the main signal 13 is received to the DAR 15, the audio program data file 40 associated with the audio program file 20 is automatically stored in the audio program information database 41. If the audio program file 20 is played immediately, or saved on the audio program library database 21 for later listening, the audio program data file 40 is used by the advertisement generator software program 65 and the advertisement play list generator software program 60 loaded into the working memory 17 to select specific audio advertisement files 30 in the audio advertisement library database 31 to play during the commercial breaks in the audio program file 20.

Using the system 10, audio advertisement files 30 are stored in the audio advertisement library database 31. The audio advertisement files 30 may be downloaded to the DAR 15 in one of four ways: (1) dark recording wherein the DAR 15 is turned off yet able to tune into a pre-selected channel and download audio advertisement files 30 to download; (2) timed recording wherein the DAR 15 is tuned on and programmed to initiate downloading at selected times; (3) alternative channel recording where audio advertisement files 30 are downloaded from a different frequency or channel; and (4) opportunity/tagged recording where the audio advertisement file 30 is recorded as it is watched and then played back at selected times.

The audio program files 20 and audio advertisement files 30 are downloaded in either compressed on uncompressed format. When initially signing up to the system 10, the listener 92 submits demographic information and information regarding the types of products and services that interest the listener 92. The service 12 assigns a unique identification number to the listener 92 or to the listener's DAR 15. When the DAR 15 is connected to the service 12, the DAR 15 queries the service's server, and transmits the listener's or DAR's identification number. If the demographic information has not been previously submitted, the listener's demographic information 93, which also may be stored on the DAR 15 is first requested and then transmitted to the server.

When the listener 92 listens an audio program file 20, the demographic information in the audio program data file 40 associated with the audio program file 20 is matched with the desired demographic information associated with the audio advertisement files 30 in the DAR's audio advertisement library database 31. During use, the advertisement audio generator software program 65 examines the information in the audio program data file 40 to determine the number of commercial breaks in the audio program file 20, their exact located in the audio program file 20 and their lengths. The advertisement audio generator software program 65 then instructs the advertisement play list generator software program 60 to select a set of audio advertisement files 30 from the audio advertisement library database 31 for listening with the audio program file 20. The advertisement play list generator software program 60 selects which audio advertisement files 30 to play and their order of play back. One function of the advertisement play list generator software program 60 is to monitor the frequency a particular audio advertisement is played in a predetermined length of time, (e.g. previous 24 hr or 7 day period). For example, if an audio advertisement file 30 has been already been played a pre-determined number of times in a selected period, the advertisement play list generator software program 60 may automatically remove the audio advertisement file 30 from the list. Another function of the advertisement play list generator software program 60 is to prevent the same audio advertising file 30 from being heard at the same time on different channels.

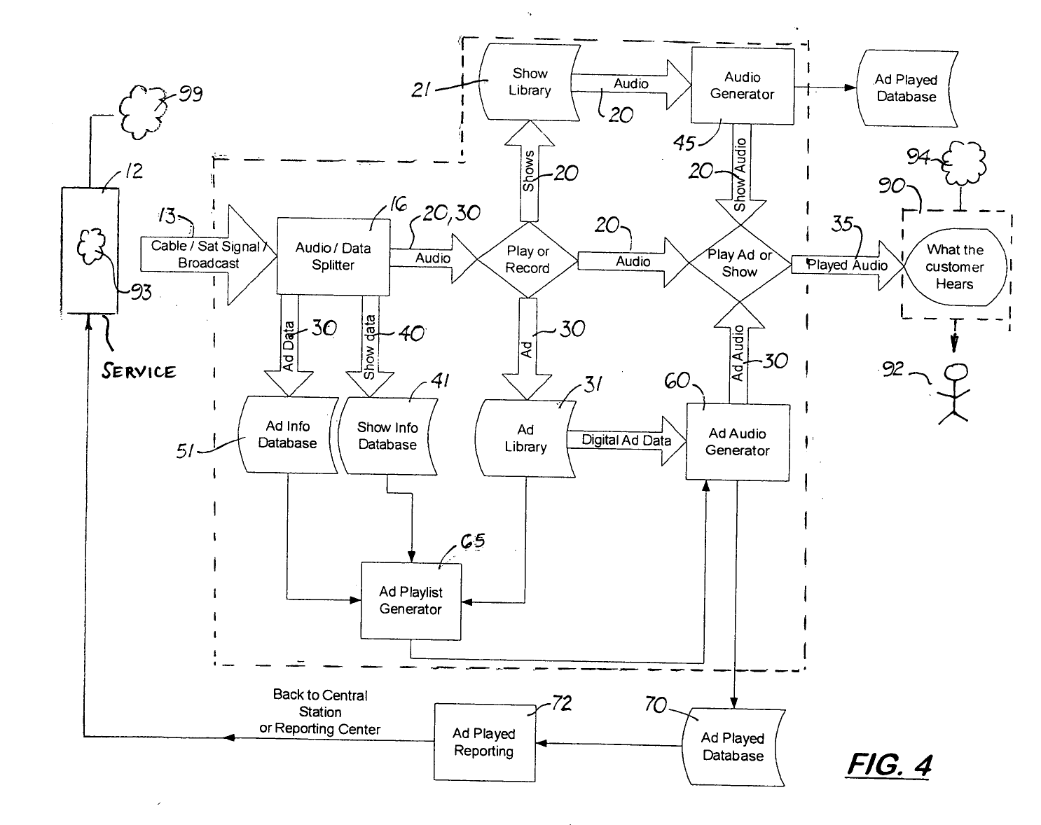

An important feature of the system 10 is that the listener 92 can selectively modify the advertisement library database 31 to delete or block specific audio advertisement files 30. In this instance, a menu 94 shown in FIG. 4 maybe provided on the display 90 that includes a deletion and a block buttons (not shown) to permanently delete or block audio advertisement 30 files from the audio advertisement library database 31.

As stated above, the audio program data file 40 contains information regarding the audio program file 20 delivered to the DAR 15. Such information includes the subject matter of the audio program file 20, its listener rating, its intended audience the number commercial breaks during the program, the length of the commercial break, and their occurrence during the audio program file 20. Such information is used by the advertisement audio generator software program 65 to select different audio advertisement files 30 in the audio advertisement library databank 31 to play back to the listener 92 when listening to an audio program file 20.

The audio advertisement files 30 are typically 15 seconds, 30 seconds or 60 seconds in length. In the preferred embodiment, the audio advertisement files 30 are delivered with the audio program file 20, the audio program data file 40, and the audio advertisement data file 50. It should be understood however, that the audio program file 20, the audio advertisement file 30, audio program data file 40, and the audio advertisement data file 50 may be delivered separately and at different times.

As noted above, the advertisement audio generator software program 65 and the advertisement play list generator software program 60 uses the audio advertisement library database 31 to present audio advertisement files when an audio program file 20 is being heard. When an audio advertisement file 30 is played back to the listener, it is recorded in audio advertisement listened database 70 also created on the audio recorder device 15. At the end of a billing cycle, the number of times a particular audio advertisement file 30 is played on the DAR 15, is submitted in a report 72 delivered to the service's billing office, which then combines the information with other billing services to prepare a final bill to the advertisers.

Because the audio program file 20 and the audio advertisement files 30 are separate files, the listener 92 is able to contact the service 12 and request that only specific types of audio advertisements be delivered to his or her DAR.

An important benefit of the system 10 is that the number of times an audio advertisement file 30 is played to the listener 92 can be accurately determined. Also, the number of times an audio advertisement file 30 is played to a targeted listener can be accurately determined.

Another benefit of the system 10 is that selected audio advertisement files 30 can be deleted or blocked by the listener 92. Such deleted or blocked audio advertisements files 30 are not charged to the advertiser.

Another benefit of the system 10 is that the exact date and time an audio advertisement file 30 is heard may be determined. Also, the specific audio program being heard when the audio advertisement files 30 is heard can be easily determined thereby provide the network more accurate targeting information.

Another benefit of the system 10 is that it allows the service 12 to present advertisements to local listeners 92 for local products and service advertisers 99.

In summary, a method of targeting advertising is provided comprising the following steps:

a. selecting an audio signal service provider;

b. selecting an audio recording device having a memory storage means capable for storing audio and data files delivered from said service provider;

c. connecting a display to said audio recording device;

d. transmitting an audio program file from said signal service provider to said audio recording device;

e. transmitting an audio program data file associated with said audio program file to said audio recording device, said audio program data file being transmitted by said service provider, said audio program data file indicate containing information regarding the targeted demographic profile of a listener of said audio program file and the timing of at least one commercial break in said audio program file;

f. transmitting at least one audio advertisement file to said audio recording device;

g. transmitting an advertisement data file to said audio recording device, said advertisement data file being associated with one said audio advertisement file and containing demographic information for a targeted listener; and,

h. selecting an advertising play list generator software program that reviews said audio program data file and said advertisement data file to generate at least one advertisement to play to a listener watching said audio program file associated with said audio program data file.

In compliance with the statute, the invention described herein has been described in language more or less specific as to structural features. It should be understood, however, that the invention is not limited to the specific features shown, since the means and construction shown is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. An audio network advertising system, comprising:
a. an audio signal service capable of transmitting a plurality of audio programs to its subscribers, an audio program file associated with each said audio program, a plurality of audio advertisements, and an audio advertisement data file associated with each said audio advertisement;
b. an audio recording device capable of receiving said audio programs, said audio recording device including a working memory and long term memory capable of recording and storing said plurality of audio programs into an audio program library and recording said audio advertisements into an audio advertisement library;
c. an advertising play list generator software program loaded into said working memory of said audio recording device, said advertising play list generator software program being used to select at least one audio advertisement from said audio advertisement library for playback during an audio program selected by a subscriber of said service; and,
d. at least one audio display connected to said audio recording device, said audio display used to present selected audio programs and selected audio advertisements from said audio recording device.

2. The audio network advertising system, as recited in claim 1, further including an audio generator software program loading into said working memory, said audio generator software program used to determine the location of advertisement breaks in said audio program file currently being viewed, the duration of the advertisement breaks in said audio program file, and the duration of advertisement breaks in said audio program file.

3. The audio network advertising system, as recited in claim 1, wherein said audio program file includes the number of advertisement breaks in said audio program file and the location of said advertisement breaks in said audio program file.

4. The audio network advertising system, as recited in claim 1, wherein said audio advertisement data file includes targeted demographic information associated with said audio advertisement file.

5. The audio network advertising system, as recited in claim 3, wherein said audio advertisement data file includes demographic information associated with the targeted listeners of said audio advertisement file.

6. The audio network advertising system, as recited in claim 1, wherein said audio program files are stored in an audio program library database directly connected to said audio recording device.

7. The audio network advertising system, as recited in claim 6, wherein said audio advertisement files are stored in an audio advertisement library database directly connected to said audio recording device.

8. The audio network advertising system, as recited in claim 7, wherein said audio program files are stored in an audio program library database connected to said audio recording device.

9. The audio network advertising system, as recited in claim 8, wherein said advertisement data files are stored in an audio advertisement information database connected to said audio recording device.

10. The audio network advertising system, as recited in claim 1, further including an audio advertisement library database coupled to said audio recording device, said audio advertisement library database used to record a plurality of said audio advertisement files from said service provider.

11. The audio network advertising system, as recited in claim 10, wherein said audio program information data files are stored in an audio program information database connected to said audio recording device.

12. The audio network advertising system, as recited in claim 11, wherein said audio advertisement data file is stored in an advertisement information database connected to said audio recording device.

13. The audio network advertising system, as recited in claim 1, wherein said audio program data file is stored in an audio program information database connected to said audio recording device.

14. An audio network advertising system, comprising:
a. an audio signal service capable of transmitting a plurality of audio programs to a subscriber, an audio program data file associated with each said audio program, a plurality of audio advertisements, and an audio advertisement data file associated with each said audio advertisement, said audio program file includes advertisement playback information which includes information on the number of advertisement audio slots in said audio program, the time location of said advertisement audio slots in said audio program, said audio advertisement data file includes targeted demographic information associated with each said audio advertisement file;
b. an audio recording device connected to said audio signal service, said audio recording device including a working memory and a means for long term memory capable of recording from said audio signal service provider a plurality of said program audios into an audio program library and recording said audio advertisements into an audio advertisement library;
c. an audio generator software program loading into said working memory, said audio generator software program used to determine the location of advertisement breaks in said audio program file currently being viewed, the duration of the advertisement breaks in said audio program file, and the duration of advertisement breaks in said audio program file;
d. an advertising play list generator software program loaded into said working memory of said audio recording device, said advertising play list generator software program used to select at least one audio advertisement from said audio advertisement library for playback during an audio program selected by a subscriber of said service, said audio advertisements being selected based on matching the targeted, demographic profile information of a listener of the audio program and the targeted, demographic profile information of the audio advertisement; and,
e. at least one audio display connected to said audio recording device, said audio display used to present selected audio programs and selected audio advertisements from said audio recording device.

15. The audio network advertising system, as recited in claim 14, wherein said audio programs are stored in an audio program data file coupled to said audio recording device.

16. The audio network advertising system, as recited in claim 14, wherein said audio advertisements are stored in an audio advertisement library data file directly connected to said audio recording device.

17. An improved method for targeting audio advertisements to a listener of an audio program, comprised on the following steps:
a. selecting an audio signal service capable of transmitting all audio program and data information associated therewith to a listener's audio recording device;
b. selecting an audio recording device connected to said audio signal service, said audio recording device having a memory storage means capable of storing audio program and data information delivered from said audio signal service said audio recording device including an advertising play list generator used to select and playback at least one advertisement stored in memory on said audio recording device that is played back to a listener while listening to an audio program on an audio recording device;
c. connecting an audio recording device;
d. transmitting an audio program file from said audio signal service to said audio recording device;
e. transmitting an audio program data file associated with said audio program file to said audio recording device, said audio program data file being transmitted by said audio signal service provider, said audio program data file containing information regarding the targeted demographic profile of a listener of said audio program file and advertisement timing information in said audio program file;
f. transmitting at least one advertisement audio programmer from said audio signal service to said audio recording device;
g. transmitting an advertisement data file associated with said advertisement audio program, said advertisement data file containing demographic information for a targeted listener; and,
h. operating said advertising play list generator software program that reviews said audio program data file and said advertisement data file to generate at least one advertisement to play to a listener watching said audio program file associated with said audio program data file.

18. The method as recited in claim 17 further including the step (i) collecting information on the number of advertisement audios shown to a listener.

19. The method as recited in claim 17, further including the step (j) billing advertisers based on the number of advertisements audio shown to said listener.

20. The method as recited in claim 17, further including the step (k) collecting demographic information about a listener and then using said listener demographic information to select an advertisement audio to be delivered to a listener.
